(19) United States
(12) Patent Application Publication
(10) Pub. No.: US 2010/0040820 A1
(43) Pub. Date: Feb. 18, 2010

(54) Composite film for a receptacle, particularly a tube

(76) Inventors: Jürgen Arz, Munchen (DE); Anja Wilma Arz, München (DE); Michael Arz, München (DE); Ruth Arz, München (DE); Georg Pescher, Lenggries (DE); Harry Johlke, GaiBach (DE)

Correspondence Address: WARNER NORCROSS & JUDD LLP, 900 FIFTH THIRD CENTER, 111 LYON STREET, N.W., GRAND RAPIDS, MI, 49503-2487, US

(21) Appl. No.: 10/593,076

(22) PCT Filed: Mar. 15, 2004
(86) PCT No.: PCT/EP04/02681

§ 371 Date: Apr. 14, 2008

(51) Int. Cl. B32B 1/08; B32B 3/10; B29C 53/04

(52) U.S. Cl. 428/36.91; 428/203; 156/218

(57) ABSTRACT

A composite film for the production of receptacles, in particular tubes, is proposed, the outer layers (1, 3) of which consist of a sealable material and between them contain an intermediate layer (5) serving as a print carrier for a decorative imprint. The sealing layers (1, 3) are laminated against the intermediate layer (5). At least the sealing layer pointing outward in the receptacle consists of transparent material. Since the intermediate layer (5) does not have to assume any sealing tasks, it can be optimized from the standpoint of printability, this being beneficial to the quality of the imprint. The margins (21) of a cut-to-size film piece (23) of the composite film which are to be connected flush to form a tubular tube blank contain clearances (25) which run along the margins (21) and which are filled, during sealing, with a material, in particular sealable material, which bonds fixedly with the outer layers (1, 3). The mechanical strength of the flush seam can be improved in this way.

The invention relates to a composite film for a receptacle, in particular a composite film for a tube, with a plurality of layers which are connected to one another in a sheetlike manner to form a layer stack and of which at least two layers consist of a material which is sealable to itself and/or to the material of the other of these two layers, and of which at least one layer is laid as an intermediate layer between these two sealing layers.

Composite films of this type are known, for example, from DE 39 05 370 A1, EP 0 484 275 A1, EP 0 622 181 A1 or EP 0 939 037 A1. For the production of tubes, cut-to-size pieces consisting of such a composite film are rolled to form a tube which is sealed along the margins of the blank which mostly overlap one another slightly. The closing head of the tube is then subsequently attached to a tubular tube blank. After the tube has been filled, that end of the tube blank which faces away from the closing head is closed.

Conventional composite films for tubes or the like are mostly between 200 and 700 μm thick, in order to ensure a rigidity of the tube which is sufficient for use. The outer layers of the layer stack of the composite film consist, as a rule, of the same sealable material, so that the margins of the cut-to-size piece of film can be permanently connected to form the tubular tube blank. In conventional composite films, between the outer sealing layers, metal films or other barrier layers are arranged, which prevent the outward migration of substances of the tube contents or the penetration of substances into the tube contents.

As a rule, tubes are printed with a decorative imprint. Conventionally, the already finished composite film is printed on its outside, mostly by letterpress printing (relief printing), so that the thickness tolerances unavoidable with regard to the comparatively thick composite films can be compensated. If, however, high-quality multicolor decorations are to be printed by this printing technique, complicated printing machines are required for this purpose, which increase the production costs disproportionately.

It is known from EP 0 622 181 A1 and EP 0 939 037 A1 to print the respectively outer film of the composite film on its outside or, by reverse printing, on its inside and then to laminate it against further layers of the composite film. This outer film, if appropriate, is transparent, so that intermediate layers, such as, for example, a metallization layer or a hologram layer, are likewise visible from outside. Admittedly, the outer layer to be printed can thereby have a thinner dimension, so that, on account of the reduced thickness tolerances, the imprint can also be printed, multicolored, by a lithographic printing method, such as, for example, by the offset printing method. Although, in such a lithographic printing method, the tube can have a multicolored decoration with a quality which is sufficient in most cases, the printing quality attainable by means of conventional composite films nevertheless does not satisfy ever-increasing requirements.

The object of the invention is to specify a composite film for the production of receptacles, particularly tubes, which can be printed so as to satisfy even high requirements and, furthermore, can be processed permanently to form receptacles, particularly tubes.

The invention proceeds from a conventional composite film for receptacles, particularly a composite film for tubes, such as is known, for example, from EP 0 622 181 A1, with a plurality of layers which are connected to one another in a sheetlike manner to form a layer stack and of which at least two layers consist of a material which is sealable to itself and/or to the material of the other of these two layers, and of which at least one layer is laid as an intermediate layer between these two sealing layers.

Proceeding from such a composite film, the above object is achieved, according to the invention, in that at least one of the intermediate layers carries a decorative imprint on at least one of its sides, and at least the sealing layer laid on one side of this printed intermediate layer carrying the imprint consists, at least in the region of the imprint, of transparent material allowing a view of the imprint.

In such a composite film, the material properties of the sealing layers, on the one hand, and of the printed intermediate layer carrying the imprint, on the other hand, can be selected independently of one another. The printed intermediate layer can be selected according to its task as a print carrier, particularly as regards the expansion properties, the modulus of elasticity in extension, the flatness properties and the flexural strength of the film forming the intermediate layer. The film material of this intermediate layer may be selected independently of sealability and primarily only from printing standpoints.

In addition to the printing requirements, films may also be selected according to whether they possess additional functions, such as, for example, barrier functions against gases and liquids. It has been shown that materials of the printed intermediate layer which are selected according to printing standpoints have even better barrier properties, for example for oxygen and/or aroma permeability, than the materials normally selected for the sealing layers.

Alternatively or even additionally, the printed intermediate layer and/or at least one of the sealing layers, preferably the sealing layer lying on the outside in the receptacle, may be coated with a barrier coating, in particular a plasma or electron-beam coating consisting of a material having low oxygen and/or aroma permeability.

In particular, an SiOₓ coating is suitable, x being equal to 1.1 to 1.7. The barrier coating preferably lies inside the composite film.

It has been shown that sealable materials, such as are required for the two sealing layers, do not, as a rule, fulfill the requirements necessary for high-quality printing methods if there is to be no impairment of the sealing properties.

A layer sealable to itself and/or to the material of the other sealing layer is to be understood here and hereafter as meaning not only a layer consisting of thermally fusible and therefore weldable material, but, in general, materials which can be fixedly connected to one another mechanically by etching with a solvent or by the application of an adhesive. For thermal fusion, all conventional methods can be adopted which allow the controlled fusion of, if appropriate, only the surface of the film margins to be connected to one another, such as, for example, heating by means of a hot-air stream, ultrasonic welding, laser welding, high-frequency welding and, in particular, inductive welding by the controlled application of a high-frequency magnetic field. In particular, the term “sealing” is to embrace here and hereafter not only thermal welding, but any type of mechanically fixed connection of the sealing layers, for example by the etching of the layers by means of solvent or by adhesive bonding by means of an adhesive.

So that the printed intermediate layer can be printed separately, the sealing layers are expediently connected to the printed intermediate layer by means of a laminating layer. However, the printed intermediate layer may also be connected to one of the two sealing layers even before printing. The advantage of this is that, if appropriate, semifinished products consisting of a composite structure of sealing layer and printed intermediate layer can also be processed.

The printed intermediate layer may be printed as a single layer with a decorative imprint, in which case the imprint may be present not only on the subsequent receptacle outside, but, by reverse printing, if appropriate, also on the inside, insofar as the printed intermediate layer, too, consists of transparent material. In order to increase the range of variation of the decoration, however, the transparent sealing layer allowing a view of the imprint of the printed intermediate layer may also carry a further imprint on at least one of its two sides. This sealing layer, too, may be printed both on its outside and, by reverse printing, on its inside. Expediently, this sealing layer carrying the imprint is thinner than the other of the two sealing layers, so as to impair the printed image as little as possible.

One or both sealing layers may be designed as a single-ply film. However, one or both sealing layers may also assume further functions and be designed as a multi-ply coextruded or laminated composite layer structure. For example, the composite layer structure of one of the two sealing layers may comprise a metallization layer and/or a hologram layer and/or a barrier layer preventing the migration of substances into the receptacle or out of the receptacle interior.

Alternatively, however, at least one of the intermediate layers may also be designed as a metallization layer and/or a hologram layer and/or as a barrier layer preventing the migration of substances and may be supplied to the composite film correspondingly in a lamination step separate from the application of the sealing layer.

The printed intermediate layer preferably consists of a material with a higher fusion temperature than the sealing temperature of the sealing layers and/or with a lower expandability than the sealing layers and/or with a higher modulus of elasticity in extension than the sealing layers and with a flexural strength equal to or lower than that of the sealing layers. The expandability of the printed intermediate layer at tear is also expediently lower than are connected. The advantage of this is that, if appropriate, also those of the sealing layers. Printed intermediate layers of this type are distorted in the printing machine to a lesser extent than the material of which the sealing layers consist and can be printed more accurately. Suitable printed intermediate layers are, for example, those consisting of polypropylene (PP), polyvinyl chloride (PVC), polyamide (PA), polystyrene (PS), poly-olefin copolymers (COPO) or polyester terephthalate copolymers (PET). Suitable sealing layers are, in particular, films consisting of polyolefins, for example polyethylene (PE), HDPE, LDPE, PP and copolymers of PE/PP. Materials of the type explained above improve the oxygen and/or aroma barrier properties of the composite film.

The thickness of the sealing layers and of the printed intermediate layer can easily be selected according to the intended use. For the tube production, at least one of the two sealing layers, in particular the sealing layer intended for forming the receptacle inside, expediently has a thickness of between 150 and 600 μm, so that this layer primarily determines the rigidity of the tube wall. At least one of the two sealing layers, in particular the sealing layer intended for forming the receptacle outside, expediently has a thickness of between 5 and 200 μm. The advantage of this is that the outer sealing layer, too, may, if appropriate, be printed before lamination. In that case, the thinner, outer sealing layer impairs the optical properties of the imprint of the printed intermediate layer only a little, even when the material of this sealing layer is transparent to only a limited extent. The printed intermediate layer preferably has a thickness of between 15 and 100 μm, so that it can be printed accurately even by lithographic printing.

For the production of a receptacle blank, especially a tube blank, the at least one intermediate layer can be laminated against a first of the two sealing layers and be printed with a decorative imprint before or after lamination, in particular after lamination. Insofar as the intermediate layer is connected to the first sealing layer before printing, the connection may also take place otherwise than by lamination, for example by coextrusion, so that a semifinished product prefabricated for this purpose can be processed. The second of the two sealing layers is then laminated against that side of the printed intermediate layer which faces away from the first sealing layer, and then mutually assigned margins of a cut-to-size film piece of the composite film thus formed are sealed to one another so as to overlap or so as to lie flush against one another. The printed intermediate layer may be printed by normal printing or by reverse printing or on both sides, the films both of the sealing layers and of the printed intermediate layer being provided as roll material or in sheet form. The cut-to-size film piece may be manufactured from the finished composite film; however, partial cuts of individual margins of the cut-to-size film piece may also be made even during individual manufacturing steps of the composite film.

In a preferred embodiment of the production method explained above, the cut-to-size pieces of the layers of the cut-to-size film piece which are to be connected to one another may be adapted to one another, for a flush connection of its margins, in such a way as to give rise, in the two margins of the cut-to-size film piece which are to be connected to one another, to a groove-shaped clearance running along the margin and located in the region of the intermediate layer or intermediate layers. This gives rise, between the two margins of the cut-to-size film piece which are to be connected to one another, to a cavity which is delimited transversely with respect to the composite film by the two sealing layers and between the sealing layers by the intermediate layers and which is filled during the sealing process with material which ensures a fixed connection of the seam margins. The production method may also be used for the production of receptacle blanks consisting of composite films other than those explained above, insofar as at least one intermediate layer, if appropriate not even printed, is provided between the two outer sealing layers. The production method therefore has independent inventive significance.

According to this method, for the manufacture of a cut-to-size film piece for the receptacle blank, there is provision for the intermediate film to be cut more narrowly than the two sealing layers along at least one of the two margins of the cut-to-size film piece which are to be connected and/or for the intermediate film to be laminated against the sealing layers transversely with respect to these margins, and offset in relation to the sealing layers, in such a way as to form, between the sealing layers, a clearance in the margin of the cut-to-size film piece, said clearance being delimited by the margin of the intermediate film or intermediate films, and for the mutually assigned margins of the cut-to-size film piece to be connected to one another, so as to lie flush against one another, at the same time with the at least partial filling of the clearance with material of the sealing layers or with material introduced between the margins additionally to the sealing, in particular adhesive material. In this respect, too, sealing is to be understood as meaning not only a thermal welding method, but any connection of the two mutually assigned margins of the cut-to-size film piece which allows a filling of the clearance either from the material of the sealing layers or from material additionally supplied.

The production methods explained above also allow an additional decoration of a first of the two sealing layers before or after the lamination of these onto the intermediate layer, but before the lamination of the second sealing layer, by the imprinting of a further decorative imprint.

The sealing layers are laminated against the inter-mediate layer preferably in line in a printing machine printing the decorative imprint. It goes without saying that the operation of laminating at least one of the two sealing layers may also be carried out independently of the printing machine in a later work step.

The invention is explained in more detail hereafter with reference to a drawing in which:

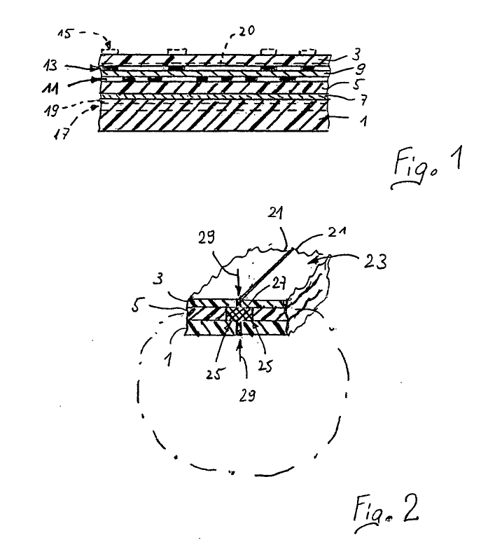

FIG. 1 shows a cross section, not true to scale, through a composite film suitable for the production of a receptacle blank, in particular a tube blank, and

FIG. 2 shows a partially diagrammatic cross section through the seam region of a tubular tube blank.

FIG. 1 shows a diagrammatic section through a composite film for tubes in the form of a layer stack of two outer layers 1, 3 consisting of a sealable, here thermally weldable material and an intermediate layer 5, by means of which the sealing layers 1, 3 are connected in a sheetlike manner via laminating layers 7, 9. The intermediate layer 5 serves as a print carrier for a decorative imprint, indicated at 11, which is to be seen through the laminating layer 9 and the sealing layer 3 consisting of transparent material and lying on the outside in the finished receptacle. The decorative imprint 11 is protected outwardly by the sealing layer 3. In addition to the decorative imprint 11, the sealing layer 3, too, carries on its inside a further decorative imprint 13 printed on by reverse printing. However, the imprint 13 may, if appropriate, be dispensed with. The sealing layer 3, too, may carry, additionally or alternatively to the imprint 13, a decorative imprint printed on the outside by normal printing, as indicated at 15. It goes without saying that the printed intermediate layer 5, too, may be provided, additionally or alternatively to the decorative imprint 11, by reverse printing with a further decorative imprint on the side laid toward the inner sealing layer 1.

For the manufacture of a tube blank, a cut-to-size film piece can be rolled to form a tube which can be connected, leaktight, at its mutually adjacent margins running along the tube axis, in an overlap seam or else along margins lying flush against one another. Insofar as the sealing layers 1, 3 consist of a thermally weldable material, the connection may take place by means of thermal welding, for example high-frequency welding, but, in particular, induction welding. Sealing may, however, also take place by adhesive bonding, for example by means of adhesive, or by etching by means of a solvent.

Whereas the material of the sealing layers 1, 3 is selected from the standpoint of optimum sealing properties and, if appropriate, sufficient transparency, the material of the printed intermediate layer 5 is selected from the standpoint of optimum printability, in particular by multicolor lithographic printing. To reduce thickness tolerances, therefore, the thickness of the printed intermediate layer 5 is between 15 and 100 μm, while the sealing layer 1 has a thickness of 150 to 400 μm. The sealing layer 3 may have a thickness of between 20 and 200 μm, with the result that it can additionally be printed particularly in the case of a small thickness. Suitable materials for the sealing layers 1, 3 are primarily polyolefins which are thermally weldable according to their fusion temperature of about 90° C. to 170° C. Suitable material for the printed intermediate layer 5 is PP, PVC, PS, PA or polyester terephthalate copolymers (PET). Films consisting of polypropylene have a fusion temperature of between about 160 and 180° C., films consisting of polyolefin copolymers (Copo PP) have a fusion temperature of between 90° and 160°, while polyester films have fusion temperatures of the order of 200° C. to 240° C. It is essential that the printed intermediate layer 5 consists of a material with an expandability at tear of less than 400%, preferably 100%, according to DIN EN ISO 527 or DIN 53371, that is to say expands to a lesser extent than the sealing layers 1, 3 normally consisting of polyethylene. The modulus of elasticity at extension of the printed intermediate layer 5 is expediently in the range of between 1200 N/mm² and 1600 N/mm², preferably between 2000 N/mm² and 2700 N/mm², according to DIN EN ISO 527. As compared with the sealing layers 1, 3, the film used as the printed intermediate layer 5 has better flatness in the printing machine. The layers used should be coordinated with one another in terms of flexural strength.

The sealing layers 1, 3 may be designed as monofilm. However, they may also take the form of a composite structure of a plurality of coextruded or laminated films and thus assume further functional tasks. Thus, the sealing layer 1, which lies on the inside of the finished tube, may, as indicated at 17, be connected to a barrier layer which prevents the outward migration of substances of the tube contents or else of substances from the outside inward. Furthermore, as indicated at 19, the sealing layer 1 may carry a metal layer, if appropriate in vapor-deposited form, which may likewise have a barrier function, but may also serve for improving the printed image. In particular, however, the metal layer 19 may also be applied to the rear side of the printed intermediate layer 5. A corresponding multilayer construction may also be envisaged for the sealing layer 3, particularly in order to improve thermal weldability.

For the production of the composite film, the printed intermediate layer 5 and, if appropriate, the sealing layer 3 are printed with the decorative imprint 11 or 13, 15. Depending on the type of imprint, the layers 3 and 5 may first be printed separately from one another, before they are laminated against one another by means of the laminating layer 9. The sealing layer 1 is then laminated against the composite structure of the layers 3 and 5 by means of the laminating layer 7. It goes without saying that, if appropriate, the printed layer 5 is also first laminated against the sealing layer 1, before the sealing layer 3 is then laminated against the composite structure thus obtained.

Cut-to-size film pieces are cut out of the composite film manufactured in this way, correspondingly to the tube blank to be manufactured, and are then rolled and sealed to one another along their margins lying against one another, using conventional methods, in an overlap seam or a flush seam. A tube head provided with a closure is attached to the tube blank at one end in the usual way.

Whereas at least the sealing layer 3 lying on the outside in the finished tube is transparent or highly transparent, the inner sealing layer 1 and, if appropriate, also the printed intermediate layer 5 may also be colored. To improve the degree of lightness of the films, these may, if appropriate, be provided additionally with additives, such as, for example, TiO₂, in order to achieve a more brilliant whiter appearance.

The possibility of designing the sealing layers 1, 3 themselves as a composite layer structure allows special optical effects, such as, for example, a matt finish, mother-of-pearl effects, soft-touch effects, hot film stamping, thermochromatic effects, barrier properties, electrical conductivity, chemical indications, selective material detection and the like. The metallization layer 19 may also be utilized in order to achieve hologram effects.

The sealing layers 1, 3 may be films consisting of high-density polyethylene (HDPE), that is to say with a density higher than 0.944 g/cm³, but also medium-density polyethylene (MDPE) with a density of 0.926 to 0.944 g/cm³. Also suitable is linear medium-density polyethylene (LMDPE) with a density of 0.926 to 0.940 g/cm³, but also low-density polyethylene (LDPE), in particular linear low-density polyethylene (LLDPE) with a density of about 0.910 to 0.925 g/cm³. Insofar as the sealing layers 1, 3 are a composite structure of a plurality of films, the polyethylene films are responsible for the sealing properties. Copolymers, such as, for example, polyethylene with vinyl acetate, vinyl alcohol or acrylic acid, or copolymerizates, such as, for example, ionomer resins (Surlyn), are also suitable.

The printed intermediate layer 5 consists expediently of amorphous or crystalline polypropylene. Insofar as the sealing layer 3 is designed as a composite layer structure and additionally comprises a print carrier layer in addition to a layer responsible for the sealing function, the print carrier layer, too, may consist of polypropylene of the above type. Atactic or isotactic or syndiotactic polypropylene is suitable in the same way. Also suitable as a print carrier in a printed intermediate layer 5 or in the sealing layer 3 is polyester, for example polyalkylene terephthalate, polyalkylene isophthalate, polyalkylene phthalate or analogous naphthalates typically with alkylene groups having 2 to 30 carbon atoms or alkylene groups, interrupted by at least one oxygen atom, of 2 to 60 carbon atoms or copolymers of the monomers, on which these are based, with glycol or other polyhydric alcohols. Particularly expedient in this case are copolymers of terephthalic acid and of ethylene glycol with a further glycol or with glycol-modified polyester (PETG), but also other polyester copolymers, such as, for example, A-PET, PETP or G-PET. Polyamides, such as, for example, polyamide-6, polyamide-11, polyamide-12, polyamide-6,6, polyamide-6,10, polyamide-6,12 or polyamide 6-3-T or mixtures thereof, are suitable. Furthermore, polyolefins, such as, for example, poly-1-butene, poly-3-methylbutene, poly-4-methylenepentene or mixtures thereof or copolymers of these materials with, for example, vinyl acetate or acrylic acid are suitable. The above materials may also be mixed with elastomers or fillers. PVC films and PS films may also be mentioned. The advantage of the materials explained above for the printed intermediate layer 5, as compared with conventional materials of the sealing layers 1, 3, is their better barrier function with respect to oxygen or aromatics. In addition, the sealing layer 3 lying on the outside in the receptacle may be provided on its inside with a barrier layer, as indicated at 20, which is applied in the usual way, for example applied by plasma or by electron beams. The barrier layer expediently consists of SiOₓ, x lying between 1.1 and 1.7.

The films used for the sealing layers 1, 3 and the printed intermediate layer 5 may be films oriented axially or biaxially by stretching, but also cast films.

The laminating layers 7, 9 may be lacquer-laminating layers or adhesive-laminating layers. In particular, dry lamination with solvent-containing or solvent-free adhesives, aqueous acrylate adhesives or polyurethane laminating adhesives is suitable.

The laminating layers 7, 9 may be UV-curable laminating adhesives or laminating lacquers or consist of hot-melt material. The use of solvent-containing single-component or multicomponent laminating adhesives based on polyurethane is preferred. The laminating adhesive is applied expediently in quantities of 0.5 to 20 g/m², preferably quantities of 2 to 10 g/m² and, in particular, in quantities of 2.5 to 6 g/m² dry weight. Application takes place preferably from a solution or dispersion with a solid content of 25 to 75%, preferably a solid content of 30 to 66% and, in particular, a solid fraction of 30 to 45%. Furthermore, UV-curing laminating adhesives with a solid content of 100% may also be used.

In order to increase and stabilize the laminating strength, the printed intermediate layer 5 and the sealing film 1 or 3 to be laminated in each case against it are subjected to flame or corona pretreatment before printing or lamination, in order to increase the surface tension and ensure optimum preconditions for a wetting and adhesion of printing inks or laminating adhesive. Alternatively, lacquerings or coatings may also be used as primer for adhesion improvement. It goes without saying that these lacquerings or coatings, in addition to adhesion improvement, may also fulfill further properties, such as, for example, a modification of the optics or improvement in the barrier properties.

The printed intermediate layer 5 and, if appropriate, also the sealing layer 3 may be printed with solvent-based inks or solvent-based lacquers, UV-inking systems, but also solvent-free inking systems, in particular on a water base.

Cut-to-size film pieces of the composite film explained above can be connected or welded to produce a tubular tube blank in an overlap seam of mutually assigned margins of the cut-to-size film piece. However, the overlap seam often impairs the external appearance of the tube. The appearance can be improved considerably if the mutually confronting margins of the cut-to-size film piece are connected to one another, for example welded to one another, so as to lie flush against one another. Owing to the comparatively small thickness of the composite film, however, the mechanical strength of such a flush seam is often insufficient, with the result that the tube may burst during squeezing-out. In order to increase the mechanical strength of the flush seam, the longitudinal margins, to be connected flush to one another, of the cut-to-size film piece 23, intended for the production of the tubular tube blank and illustrated as a detail in FIG. 2, have integrally formed into them slot-shaped or groove-shaped clearances 25 which are delimited transversely with respect to the film plane by the sealing layers 1, 3 and otherwise by the margin of the printed intermediate layer 5, said margin being drawn into the film against the margin of the sealing layers 1, 3. The clearances 25 lying opposite one another and extending along the margins 21 are filled with a material 27 bonding fixedly with the material of the sealing layers 1, 3, so that the strength of the flush seam is determined not only by the end face of the sealing layers 1 and 3 lying flush against one another, but also by the material 27 which encroaches onto the flat sides of the sealing layers 1, 3 and fills the clearances 25. Insofar as the material 27 can also make a bond with the printed intermediate layer 5, the strength is further increased.

The material 27 is preferably the material of the sealing layers 1, 3 which is fused during the thermal sealing of the sealing layers 1, 3 by the margins 21 and which penetrates into the clearances 25. During thermal welding, as indicated by arrows 29 in FIG. 2, the sealing layers 1, 3 are fused separately from opposite sides, for example by means of high-frequency welding or, in particular, induction welding on both sides.

However, the material 27 may also be sealing material supplied separately and additionally, for example in the form of sealable plastic or hot-melt material. However, single-component or two-component adhesives are also suitable.

The clearance may be worked, for example ground, into the margin 21 of the finished cut-to-size film piece 23. Expediently, however, the clearance 25 is produced even during film manufacture, in that the cut-to-size film piece of the printed intermediate layer 5 has a narrower form than the cut-to-size film piece of the sealing layers 1, 3 subsequently to be laminated together with the printed intermediate layer 5. At least for the production of one of the two margins, however, the printed intermediate layer 5 may also be laminated in an offset manner against the sealing layers 1, 3 to be laminated on.

1. A composite film for receptacles, in particular a composite film for tubes, with a plurality of layers (1, 3) connected to one another in a sheetlike manner to form a layer stack and consisting of a material which is sealable to itself and/or to the material of the other of these two layers (1, 3), and of which at least one layer is laid as an intermediate layer (5) between these two sealing layers (1, 3), characterized in that at least one of the intermediate layers (5) carries a decorative imprint (11) on at least one of its sides, and at least the sealing layer (3) laid on one side of this printed intermediate layer (5) carrying the imprint (11) consists, at least in the region of the imprint (11), of transparent material allowing a view of the imprint (11).

2. The composite film as claimed in claim 1, characterized in that at least one of the sealing layers (1, 3), preferably both sealing layers (1, 3), are connected to the printed intermediate layer (5) by means of a laminating layer (7, 9).

3. The composite film as claimed in claim 1, characterized in that the transparent sealing layer (3) allowing a view of the imprint (11) of the printed intermediate layer (5) carries a further imprint (13, 15) on at least one of its sides.

4. The composite film as claimed in claim 3, characterized in that the sealing layer (3) carrying the imprint (13, 15) is thinner than the other (1) of the two sealing layers (1, 3).

5. The composite film as claimed in claim 1, characterized in that one or both sealing layers (1, 3) are designed as a single-ply film or as a multi-ply coextruded or laminated composite layer structure.

6. The composite film as claimed in claim 5, characterized in that the composite layer structure of one of two sealing layers (1, 3) comprises a metallization layer (19) and/or a hologram layer and/or a barrier layer (17) preventing the migration of substances.

7. The composite film as claimed in claim 1, characterized in that at least one of the intermediate layers is designed as a metallization layer (19) and/or a hologram layer and/or as a barrier layer (17) preventing the migration of substances.

8. The composite film as claimed in claim 1, characterized in that the printed intermediate layer (5) consists of a material with a higher fusion temperature than the sealing temperature of the sealing layers (1, 3) and/or with a lower expandability at tear than the sealing layers (1, 3) and/or with a higher modulus of elasticity at extension than the sealing layers (1, 3).

9. The composite film as claimed in claim 1, characterized in that at least one of the two sealing layers (1, 3), in particular the sealing layer (1) intended for forming the receptacle inside, has a thickness of between 150 and 400 μm.

10. The composite film as claimed in claim 1, characterized in that at least one of the two sealing layers (1, 3), in particular the sealing layer (3) intended for forming the receptacle outside, has a thickness of between 20 and 200 μm.

11. The composite film as claimed in claim 1, characterized in that the printed intermediate layer (5) has a thickness of between 15 and 100 μm.

12. The composite film as claimed in claim 1, characterized in that a barrier layer (20) for reducing the permeability of the composite film to oxygen and/or aromatics is applied, in particular applied by a plasma method or an electron-beam method, to the printed intermediate layer (5) and/or to at least one of the sealing layers (1, 3).

13. The composite film as claimed in claim 12, characterized in that the barrier layer (20) is applied to the inside of the sealing film lying on the outside in the receptacle.

14. The composite film as claimed in claim 12, characterized in that the barrier layer (20) consists of SiOₓ, with x being between 1.1 and 1.7.

15. A receptacle, in particular a tube, with a wall consisting of a cut-to-size film piece of a composite film as claimed in claim 1.

16. A method for producing a receptacle blank, in particular a tube blank, from composite film as claimed in claim 1, the composite film comprising a plurality of layers (1, 3, 5) which are connected to one another in sheetlike manner to form a layer stack and of which at least two layers (1, 3) consist of a material which is sealable to itself and/or to the material of the other of the two layers (1, 3), and of which at least one layer is laid as an intermediate layer (5) between these two sealing layers (1, 3), characterized in that the at least one intermediate layer (5) is connected to a first of the two sealing layers (1, 3), in particular laminated against the first of the two sealing layers (1, 3), and is printed with a decorative imprint (11) before or after connection, in that the second of the two sealing layers (1, 3) is then laminated against that side of the printed intermediate layer (5) which faces away from the first sealing layer, and in that mutually assigned margins (21) of a cut-to-size film piece (23) are then sealed to one another so as to overlap or so as to lie flush against one another.

17. The method for producing a receptacle blank, in particular a tube blank, as claimed in claim 16, characterized in that, in the two margins (21) of the cut-to-size film piece (23) which are to be connected flush to one another, a groove-shaped clearance (25) running along the margin (21) is provided in the region of the intermediate layer (5) or intermediate layers.

18. A method for producing a receptacle blank, in particular a tube blank, from a composite film which comprises a plurality of layers (1, 3, 5) which are connected to one another in a sheetlike manner to form a layer stack and of which at least two layers (1, 3) consist of a material which is sealable to itself and/or to the material of the other of the two layers (1, 3), and of which at least one layer is laid as an intermediate layer (5) between the two sealing layers (1, 3), characterized in that, for the manufacture of a cut-to-size film piece (23) for the receptacle blank, the intermediate layer (5) is cut more narrowly than the two sealing layers (1, 3) along at least one of the two, preferably both margins (21) of the cut-to-size film piece (23) which are to be connected and/or is connected to the sealing layers (1, 3) in particular laminated against the sealing layers (1, 3), transversely with respect to this margin, and offset in relation to the sealing layers (1, 3), in such a way that a clearance (25) delimited by the margin of the intermediate layer (5) or intermediate layers is formed in the margin of the cut-to-size film piece (23) between the sealing layers (1, 3), and in that the mutually assigned margins (21) of the cut-to-size film piece (23) are connected to one another, so as to lie flush against one another, at the same time with at least partial filling of the clearances (25) with the material of the sealing layers (1, 3) or with material, in particular adhesive material, additionally introduced between the margins.

19. The method for producing a receptacle blank, in particular a tube blank, as claimed in claim 18, characterized in that the receptacle blank is produced from a composite film with a plurality of layers (1, 3) connected to one another in a sheetlike manner to form a layer stack and consisting of a material which is sealable to itself and/or to the material of the other of these two layers (1, 3), and of which at least one layer is laid as an intermediate layer (5) between these two sealing layers (1, 3), characterized in that at least one of the intermediate layers (5) carries a decorative imprint (11) on at least one of its sides, and at least the sealing layer (3) laid on one side of this printed intermediate layer (5) carrying the imprint (11) consists, at least in the region of the imprint (11), of transparent material allowing a view of the imprint (11).

20. The method for producing a receptacle blank, in particular a tube blank, as claimed in claim 18, characterized in that the at least one intermediate layer (5) is connected to a first of the two sealing layers (1, 3), in particular is laminated against the first of the two sealing layers (1, 3), and is printed with a decorative imprint (11) before or after connection, in particular also connection, in that the second of the two sealing layers (1, 3) is then laminated against that side of the printed intermediate layer (5) which faces away from the first sealing layer, and in that the mutually assigned margins (21) of the cut-to-size film piece (23) are then connected flush to one another.

21. The method for producing a receptacle blank, in particular a tube blank, as claimed in claim 16, characterized in that a first of the two sealing layers (1, 3) is printed with a further decorative imprint (13, 15) before or after being laminated onto the intermediate layer (5), but before the second sealing layer is laminated on.

22. The method for producing a receptacle blank, in particular a tube blank, as claimed in claim 16, characterized in that the sealing layers (1, 3) are laminated against the intermediate layer (5) in line in a printing machine printing the decorative imprint (11).

23. The method for producing a receptacle blank, in particular a tube blank, as claimed in claim 16, characterized in that the mutually assigned margins (21) of the cut-to-size film piece (23) are sealed flush to one another by induction welding or high-frequency welding.

24. The method for producing a receptacle blank, in particular a tube blank, as claimed in claim 16, characterized in that the cut-to-size film piece (23) is shaped to form a tubular tube blank by means of the sealing of two margins lying opposite one another.
